(19) United States
(12) Patent Application Publication
(10) Pub. No.: US 2025/0026238 A1
(43) Pub. Date: Jan. 23, 2025

(54) Balancing States of Charge of Battery Modules for an Electric Vehicle

(71) Applicant: Bayerische Motoren Werke Aktiengesellschaft, Muenchen (DE)

(72) Inventors: Hans GLONNER, Pfaffenhofen (DE); Dirk HOHMANN, Hebertshausen (DE); Thomas VOGL, Muenchen (DE)

(21) Appl. No.: 18/714,920

(22) PCT Filed: Jan. 10, 2023
(86) PCT No.: PCT/EP2023/050363

§ 371 Date: May 30, 2024

(30) Foreign Application Priority Data
Jan. 27, 2022 (DE) 10 2022 101 927.6

(51) Int. Cl. B60L 58/21; B60L 53/80; B60L 58/13; B60L 58/22

(52) U.S. Cl. CPC B60L 58/21; B60L 53/80; B60L 58/13; B60L 58/22

(57) ABSTRACT

An electric vehicle includes a battery modules electrically connected in parallel and having the same nominal module voltage, a determination device for determining a battery state parameter representing a state of charge of the battery module; a switching system to switch current paths of the battery modules to be conducting or blocking; an energy management system configured to, if a battery module has a state of charge that is noticeably lower than a state of charge of another battery modules, switch the current path of the battery module with the lower state of charge to be blocking during a driving mode until the charging state of the battery module with the higher state of charge is balanced with the charge state of the battery module with the lower state of charge, and then switch the current path of the battery module with the lower state of charge to be conductive.

### BACKGROUND AND SUMMARY

The invention relates to an electric vehicle, having a plurality of battery modules with the same nominal module voltage, a determination device for determining at least one battery state parameter that represents a state of charge of the battery modules; a switching system that is designed to switch current paths of the battery modules to be individually conducting or blocking; a power management system that controls the switching system. The invention also relates to a method for balancing states of charge of a plurality of battery modules with the same nominal module voltage of an electric vehicle, in which at least one battery state parameter that represents a state of charge of the battery modules is determined. The invention is advantageously applicable, in particular, to electrically powered motorcycles and small vehicles.

For electric vehicles, it is desirable to provide small and lightweight batteries which provide sufficient electrical power for operating, in particular for powering, the electric vehicle. However, small, lightweight lithium-ion battery modules can only provide a relatively small amount of electrical power, which means that they are generally only found in low-output electric vehicles.

The interconnecting of battery modules to increase the electrical power provided is known. This brings with it the problem that the battery modules can have a different state of charge, which can manifest itself disadvantageously, for example, in deviating module voltages which can become so great that interconnecting the battery modules is not possible because of the high compensating currents which then occur. A known possibility for balancing different module voltages while the electric vehicle is being operated consists in using DC/DC converters which, however, require a large installation space and are also expensive. A further possibility consists in balancing the states of charge of the battery modules by individually charging and discharging during a joint charging operation at a charging station.

A discharge control system of an electric storage pack, disclosed in EP 2 056 422 A1, has a multiplicity of electrically rechargeable cells which are connected in series, and a discharge line is connected from an electrically rechargeable cell to a load drive power supply circuit. The discharge control system comprises cell voltage detection units for detecting respective cell voltages of the multiplicity of cells, a switch group that consists of a multiplicity of switches connected between the multiplicity of cells, and a control unit that individually turns on/off a cell designated as having a highest cell voltage in the multiplicity of electrically rechargeable cells, which cell has the electric storage pack, in accordance with the detection results by the cell voltage detection units and the switches of the switch group, in order to a discharge line from an electrically rechargeable cell of the group to the load drive power supply circuit.

For supplying power to electronic circuits, EP 2 879 266 A1 discloses a power management method for a rechargeable stacked cell power storage device, which comprises: monitoring state parameters of individual cells in the rechargeable stacked cell power storage device; and selectively connecting cells having a load in accordance with the state parameter of the cells.

An object of the present invention is to at least partially overcome the disadvantages of the prior art and, in particular, to provide a simple and inexpensively implementable way of balancing states of charge of a plurality of battery modules of an electric vehicle.

This object is achieved in accordance with the features of the present disclosure. Preferred embodiments can also be gathered, in particular, from the present disclosure.

The object is achieved by an electric vehicle, having
a plurality of battery modules which are electrically connected in parallel and have the same nominal battery voltage,
a determination device for determining at least one battery state parameter that represents a state of charge of the battery modules;
a switching system that is designed to switch current paths of the battery modules to be individually conducting or blocking;
a power management system that is connected to the determination device, controls the switching system and is designed,
when at least one of the battery modules has a state of charge that is markedly lower than a state of charge of at least one other of the battery modules, to switch the current path of the at least one battery module with the lower state of charge to be blocking while the electric vehicle is being driven, until the state of charge of the at least one battery module with the higher state of charge has balanced to the state of charge of the at least one battery module with the lower state of charge, and
then to switch the current path of the at least one battery module with the previously lower state of charge to be conducting.

This electric vehicle has the advantage that balancing the states of charge of the battery modules can be undertaken with very low switching effort. Moreover, by balancing while the vehicle is being driven, this is advantageously performed in the background, virtually unnoticed by the user of the electric vehicle. Furthermore, this results advantageously in the balancing being independent of charging operations for charging the battery modules.

The electric vehicle can be a hybrid vehicle or a fully electrically powered vehicle.

In an electric vehicle, the battery modules serve to at least drive it and can therefore also be referred to as “drive battery modules”. It is a further development that the battery modules are additionally provided for supplying power to at least one electric drive motor for operating further consumers (“secondary consumers”), e.g. for light, displays, braking, steering, etc. Besides these battery modules, in a further development a further electrical power storage device can be provided only for supplying power to the secondary consumers.

As a result of the battery modules being electrically connected in parallel, the available power increases with the number of battery modules, which means that, for example, the range of the electric vehicle and/or its highest speed can be increased.

A battery module is understood in particular to mean a battery unit that can be handled independently and can be connected, for example, to the onboard power supply network of the electric vehicle via corresponding poles. A battery module can have one or more battery cells which are connected appropriately in a generally known manner. The battery modules have a certain nominal module voltage and a certain nominal output. An actual module voltage of a battery module can be measured via its contacts or poles. Its terminal voltage, in particular, can also be measured while the vehicle is being driven.

It is a further development that the battery modules are of the same electrochemical type. It is a further development that the battery modules, or the battery cells contained therein, are lithium-ion accumulators which advantageously have a higher specific power than other commercially available types of accumulator.

The determination device is designed to determine at least one battery state parameter that represents a state of charge of the battery modules. The determination can comprise or be a measurement, in which case the determination device can also be referred to as a measurement device. However, the determination can also comprise a calculation of a battery state parameter from one or more measurement values. The determination device can, for example, comprise an AD converter for converting physical measurement signals into digital measurement values and optionally a data processing device such as a microprocessor, ASIC, FPGA, etc. for further processing of the measurement data into data derived therefrom. The fact that a battery state parameter represents the state of charge of a battery module (also known as SoC, “State of Charge”) can mean, in particular, that the state of charge can be deduced from the battery state parameter, e.g. the state of charge can be calculated or estimated. For example, the present module voltage is a suitable battery state parameter, since the module voltage also increases with a higher state of charge and therefore the module voltage can be used as a direct measure of the state of charge.

The switching system comprises in particular a multiplicity of electrically operable switches such as electronic switches (e.g. transistors), mechanically switching switches (e.g. relays), etc.

The fact that current paths of the battery modules can be switched to be individually conducting or blocking comprises the fact, in particular, that a battery module with a current path that is switched to be conducting is electrically connected to the electric circuit or the power supply network of the electric vehicle and is available for the supply of power to the electric vehicle. This battery module is then “connected”. A battery module with a current path that is switched to be blocking is electrically separated from the electric circuit and is not available for supplying power to the electric vehicle. This battery module is then “disconnected”. The ability to controllably switch in a conducting or blocking manner can be implemented in such a way, for example, that a switch is electrically wired in series with an associated battery module: if the switch is open, the electric circuit is disconnected and therefore switched to be blocking; when the switch is closed, the circuit is switched to be conducting. This is particularly simple to implement. However, it is possible to use other switching topologies.

The power management system serves in particular to make the presently required electrical power available to the electrical consumers of the vehicle.

The fact that the power management system is connected to the determination device comprises, in particular, the fact that data determined or identified by the determination device, e.g. measurement data such as a module voltage, etc., and/or data derived therefrom such as the state of charge, etc., can be used by the power management system to control the switching system.

The fact that the power management system can control the switching system comprises in particular the fact that it can correspondingly switch the switches of the switching system, e.g. can open them or close them.

The fact that a battery module has a state of charge that is “markedly lower” than a state of charge of another battery module can mean, in particular, that the states of charge (i.e. a battery state parameter that represents the state of charge or the state of charge SoC derived therefrom as such) differ from one another more significantly than a prescribed tolerance.

The fact that the current path of the at least one battery module with the lower state of charge is switched to be blocking while the electric vehicle is being driven, therefore this at least one battery module is disconnected from the power supply of the electric vehicle, has the effect that only the at least one battery module with the higher state of charge in relation thereto is then available for supplying electrical power to the electric vehicle. While driving, only the at least one battery module with the higher state of charge is then discharged by at least one electrical consumer, with the result that its state of charge decreases.

The fact that this state is maintained until the state of charge of the at least one battery module with the higher state of charge has balanced to the state of charge of the at least one battery module with the lower state of charge comprises the fact that the state is maintained until the states of charge differ from one another by less than the prescribed tolerance. If this is the case, the battery module with the lower state of charge is connected or attached to the power supply again.

It is a configuration that the at least one battery state parameter is a module voltage of the battery module, in particular the terminal voltage of the battery module. This is particularly advantageous because the module voltage can be measured comparatively simply, is already frequently measured in electric vehicles and the module voltage additionally represents a reliable measure of the state of charge. In this case, the electric vehicle can be designed in such a way, for example, that the determination device is a measurement device for measuring the module voltages of the battery modules and the power management system is designed,
when at least one of the battery modules has a module voltage that is markedly lower than a module voltage of at least one other of the battery modules, to switch the current path of the at least one battery module with the lower module voltage to be blocking while the electric vehicle is being driven, until the module voltage of the at least one battery module with the higher module voltage has balanced to the module voltage of the at least one battery module with the lower module voltage, and
then to switch the current path of the at least one battery module with the previously lower module voltage to be conducting.

It is a configuration that the electric vehicle has at least one receptacle for the plurality of battery modules which can be removed from their receptacle by the user and can be charged by the user. This therefore achieves the advantage that the balancing of the states of charge can also be performed without further effort for battery modules individually by a user or by a service authority tasked by the user. Joint charging of the battery modules at a charging station, e.g. a charging post, can be dispensed with. This is particularly advantageous for electric vehicles that do not have a charging socket or an inductive charging sensor. As a result, such electric vehicles can be kept particularly small, compact and inexpensive. In particular, a user can then also charge the battery modules at home via a charging adapter connected to the domestic power supply network, for example plugged into a power outlet, without requiring a wall box, for example. A further advantage of charging the battery modules outside of the electric vehicle consists of the fact that the electric vehicle can then also be fitted and operated in a selective manner with fewer than the maximum number of battery modules. This can save having to carry “half-empty” battery modules.

It is a further development that the battery modules together can provide an electrical output of at least 11 kW. This is advantageous for enabling the easy movement of the electric vehicle with at least one or even a plurality of users, optionally also with a payload, along the road with the flow of traffic.

It is a configuration that a single battery module can provide an electrical (nominal) output of up to 7 kW.

It is a configuration that the electric vehicle is an electrically powered motorcycle. This can be configured particularly advantageously as described above, because removable battery modules that can be charged by the user help to avoid significantly increasing the small installation space specifically for motorcycles. In addition, the low weight of electrically powered motorcycles means that only a few battery modules are sufficient to allow them to move fluidly through traffic.

It is a configuration that the electric vehicle is an electrically powered small car. Removable battery modules that can be charged by the user are useful here too in maintaining a compact size and an inexpensive construction.

It is a configuration that the electric vehicle has a receptacle for precisely two battery modules. This saves installation space and costs. Furthermore, this advantageously keeps the implementation outlay for the battery management system particularly low.

It is a further development that the electric vehicle has a receptacle for more than two battery modules, which advantageously increases the electrical power available to the electric vehicle. In this case, the battery modules can also be balanced in stages, optionally in groups. This could then be performed, by way of example, using three battery modules B1, B2 and B3, which have different states of charge SoC (B1)>SoC (B2)>SoC (B3) outside of their tolerances, which can also be represented by the module voltages V, for which V (B1)>V (B2)+ΔV>V (B3)+ΔV then applies, with ΔV being the tolerance for the module voltages.

In one possible balancing schema, initially the battery modules B2 and B3 are disconnected, and therefore only battery module B1 supplies the electric vehicle with power. As a result, the battery module B1 discharges, until V (B1)=V (B2)+ΔV or until V (B1)=V (B2) applies. The battery module B2 is then connected again, and therefore the electric vehicle is now supplied with power by the battery modules B1 and B2. As a result, both battery modules B1 and B2 discharge, until V (B1)=V (B2)+ΔV=V (B3)+ΔV or until V (B1)=V (B2)=V (B3) applies. The battery module B3 is then also connected to the onboard power supply network again. This further development has the advantage that the voltage difference across all three battery modules B1 to B3 can be reduced particularly rapidly.

In another possible balancing schema, initially only the battery module B3 is disconnected, and therefore the electric vehicle is supplied with electrical power by the group of battery modules B1 and B2. As a result, the battery modules B1 and B2 discharge, until V (B2)=V (B3)+ΔV or until V (B2)=V (B3) applies. The battery module B2 is then disconnected, and therefore the electric vehicle is now only supplied with power by the battery module B1. As a result, the battery module B1 discharges, until V (B1)=V (B2)+ΔV=V (B3)+ΔV or until V (B1)=V (B2)=V (B3) applies. The battery modules B2 and B3 are then connected to the onboard power supply network again. This schema has the advantage that, at the beginning of a driving operation, a comparatively large amount of electrical power is available, which may be advantageous in cold ambient temperatures when starting, for example.

The balancing schemas above can be adapted for more than three battery modules in the same way. Further balancing schemas can also be provided, the complexity of which can increase with the number of battery modules available for supplying power. The balancing schemas can also take into account discharge operations of different speeds.

It is a further development that the tolerance for the module voltages lies in a range between 0.25 V and 0.75 V, specifically around 0.5 V.

It is a configuration that the battery modules have the same nominal output (depending on the style or type of construction).

It is a configuration that at least two of the battery modules have a different nominal output. This can be advantageous for enabling a user to flexibly adapt the output of their electric vehicle. In this case, the balancing schemas can be adapted to the nominal outputs of the battery modules, e.g. in such a way that with equal measured module voltages, a battery module with a lower nominal output is discharged before or after a battery module with a higher nominal output.

It is a configuration that the power management system is designed to switch the current paths of at least enough battery modules to be conducting that a power requirement of the electric vehicle can be met by the battery modules that are switched to be conducting. This is advantageous for preventing a required or requested power consumption of the electric vehicle, resulting from the driving operation, from also being accessible by the battery modules, e.g. because an overtaking maneuver or uphill driving is being performed, a consumer such as an air conditioning unit is switched on, etc. If the required power consumption is above the power made available by the at least one connected battery module, the balancing process can be interrupted, by all the battery modules being connected, for example, and/or by it being possible to alternate between different balancing schemas. In the above example with three battery modules, there could be the case, for example, where initially the required power is covered by one battery module, wherein then the above first balancing schema is performed, in which only the battery module B1 is connected. If more power is then required than can be made available by the battery module B1, a switch can be made to the above second balancing schema, in which the battery module B2 is also connected. If this too is insufficient, all three battery modules B1 to B3 can be connected. If the power requirement then decreases again, e.g. because an overtaking operation has been completed or the electric vehicle is caught in slow-moving traffic, the balancing operation can be resumed, etc.

It is a configuration that the at least one receptacle is fitted with the battery modules, in particular with all the battery modules. However, in principle an only partial fitting is also possible, which reduces the weight of the electric vehicle. For example, a small car can be fitted with fewer than the maximum possible number of battery modules, if the payload is small and/or if the anticipated route is short.

The object is also achieved by a method for balancing states of charge of a plurality of battery modules, which are electrically connected in parallel and have the same nominal module voltage, of an electric vehicle, in which, while the electric vehicle is being driven,
at least one battery state parameter that represents a state of charge of the battery modules is determined,
when at least one of the battery modules has a state of charge that is markedly lower than a state of charge of at least one other of the battery modules, the at least one battery module with the lower state of charge is disconnected until the state of charge of the at least one battery module with the higher state of charge has balanced to the state of charge of the at least one battery module with the lower state of charge, and
then the at least one battery module with the lower state of charge is connected.

The method can be designed in the same way as the electric vehicle, and vice versa, and has the same advantages.

The above-described properties, features, and advantages of this invention, and the way in which these are achieved, will become clearer and more comprehensible in conjunction with the following schematic description of an exemplary embodiment that is explained in greater detail with reference to the drawings.

### BRIEF DESCRIPTION OF THE DRAWINGS

FIG. 1 shows a sketch of an electric vehicle, designed according to the invention, with two battery modules; and

FIG. 2 shows a possible method sequence for balancing the state of charge of the battery modules of the electric vehicle from FIG. 1.

### DETAILED DESCRIPTION OF THE DRAWINGS

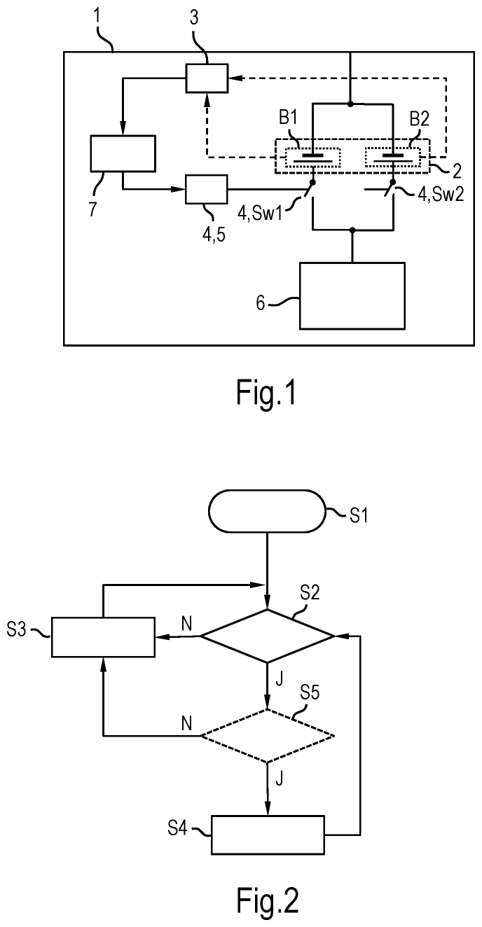

FIG. 1 shows a sketch of an electric vehicle 1, e.g. a fully electrically powered motorcycle, which has a receptacle 2 for two battery modules B1 and B2 which in the present case are inserted into the receptacle 2, and are therefore available as electrical power storage devices for operating the electric vehicle 1. The battery modules B1 and B2 here are designed as lithium-ion accumulators with the same nominal module voltage and the same or different nominal output, which are connected to one another electrically in parallel.

The battery modules B1 and B2 can be removed from their receptacle 2 by the user and can be charged by the user, e.g. by connecting to a charging adapter that can be connected to a domestic power supply network. The battery modules B1, B2 together can advantageously provide the electric vehicle 1 with an electrical output of at least 11 kW.

A determination device 3 of the electric vehicle 1 is designed to measure battery state parameters in the form of a module voltage V (B1) or V (B2) applied to the poles or terminals of the battery modules B1, B2, respectively. For the purposes of balancing the states of charge of the battery modules B1, B2, the module voltages V (B1), V (B2) are sufficiently precise representatives of the state of charge of the respective battery module B1 or B2. Therefore, the module voltages V (B1), V (B2) can be used directly as a measure of the state of charge of the respective battery module B1, B2. Alternatively, the determination device 3 can calculate the respective state of charge from the module voltages V (B1), V (B2), optionally further battery state parameters such as a state of health, etc. and/or from yet further parameters such as an ambient temperature, etc., e.g. by means of a formula, by means of a characteristic diagram, etc. That variant in which the module voltages V (B1), V (B2) are used directly as a measure of the state of charge will be described further hereinafter.

The electric vehicle 1 furthermore has a switching system 4 that is designed to switch current paths of the battery modules B1, B2 to be individually conducting or blocking. For this purpose, the switching system 4 has two electrically switchable switches Sw1 and Sw2 here, which are electrically connected in series with an associated battery module B1 or B2. The switches Sw1, Sw2 are switchable by means of a control device 5, by means of which the switches Sw1 and Sw2 can be switched optionally to be individually conducting or blocking. For example, the switches Sw1, Sw2 can be mechanically switching switches such as relays, etc. and/or electronic switches such as transistors, etc. If the switches Sw1, Sw2 are switched to be conducting, they are attached or connected to a power supply network for supplying power to at least one electrical drive 6 and optionally further electrical consumers. If the switches Sw1, Sw2 are switched to be blocking, they are detached or disconnected from the power supply network.

The determination device 3 and the switching system 4 are connected to a power management system 7. The power management system 7 can receive values of the module voltages V (B1), V (B2) from the determination device 3 and can instruct the switching system 4 to switch the switches Sw1 and/or Sw2 into a desired switching position. In one variant, the power management system 7 and the switching system 4 can be integrated in one another, with the result that the power management system 7, for example, then also assumes the function of the switching system 4 and can directly switch the switches Sw1 and Sw2, for example. In an additional or alternative variant, the power management system 7 and determination device 3 can be integrated in one another, with the result that the power management system 7, for example, can then receive the physical voltage signals from the battery modules B1, B2 and can convert them, for example, into digital measurement values and optionally process them further.

By way of example, a more detailed description will be given below of the case where the battery module B2 has a markedly lower charge voltage V (B2) than the battery module B1, therefore V (B1)>V (B2)+ΔV applies, where ΔV is the tolerance. This can be established by simply comparing the module voltages V (B1) and V (B2) measured by the determination device 3, for example whether V (B1)−V (B2)>ΔV applies. The opposite case, which is not carried out, where V (B2)>V (B1)+ΔV, is applicable in the same way. ΔV lies advantageously in a range between 0.25 V and 0.75 V, specifically around 0.5 V.

For the above case V (B1)>V (B2), the power management system 7 is designed to switch switch Sw2 to be blocking, while switch Sw1 is switched to be conducting or remains conducting. This switching state remains in place until the module voltage V (B1) has discharged, by discharging while driving, in particular by the electric drive 6, to the extent that V (B1)≈V (B2) applies which, depending on programming, can correspond to one of the conditions V (B1)<V (B2)+ΔV or V (B1)≡V (B2). After this balancing, the switch Sw2 is switched to be conducting again, and both battery modules B1 and B2 are then, with at least approximately the same module voltages V (B1), V (B2), connected or attached to the power supply network.

This sequence is illustrated in FIG. 2 again for the case. In a first step S1, the electric vehicle 1 is turned on by a user for a driving operation.

In a following step S2, a check is made as to whether the condition V (B1)>V (B2)+ΔV or the condition V (B2)>V (B1)+ΔV is present.

If this is not the case (“N”) and the module voltages V (B1) and V (B2) lie within their tolerance, therefore V (B1)≈V (B2) applies, step S2 is performed again. In between, in a third step S3, both switches Sw1 and Sw2 are switched to be conducting. If they are already switched to be conducting, they remain switched to be conducting.

If, however, this is the case (“Y”), in step S4 the battery module B2, which has the lower module voltage V (B2), is disconnected from the power supply network, or remains disconnected if it was already disconnected. Then the sequence branches back to step S2.

Checking of the deviation of the module voltages V (B1) and V (B2) from one another in step S2 can be repeated cyclically, e.g. every 0.1 to 1 s.

The steps S4 are performed subject, in particular, to the situation where the presently connected battery module B1 can supply sufficient electrical power to operate the electric vehicle 1. If this is not the case, both battery modules B1 and B2 are or remain connected. This can be implemented in the method sequence above in such a way that, between step S2 and step S3, a step S5 is performed in which a request is made as to whether the electrical power requested by the electric vehicle 1 is higher—alternatively, is the same as or higher—than the electrical power that can be provided by the battery module B1 with the higher module voltage V (B1). If this is the case (“Y”), the sequence goes to step S4, otherwise (“N”) it branches to step S3. This ensures that there are always enough battery modules B1, B2 connected that a power requirement of the electric vehicle 1 can be met by the connected battery modules B1, B2.

Of course, the present invention is not limited to the exemplary embodiment shown.

In general, “a”, “an”, etc. can be understood to mean a singular or a plural, in particular within the meaning of “at least one” or “one or more”, etc., as long as this is not explicitly excluded, for example by the phrase “precisely one”, etc.

A figure can also include precisely the specified number as well as a standard tolerance range, as long as this is not explicitly excluded.

### LIST OF REFERENCE SIGNS

1 electric vehicle
2 receptacle for battery modules
3 determination device
4 switching system
5 control device
6 electric drive
7 power management system
B1 battery module
B2 battery module
Sw1 switch
Sw2 switch
S1-S5 method steps
V (B1) module voltage
V (B2) module voltage
ΔV tolerance

1-12. (canceled)

13. An electric vehicle comprising:
a plurality of battery modules that are electrically connected in parallel and have a same nominal module voltage;
a determination device configured to determine at least one battery state parameter that represents a state of charge of the battery modules;
a switching system configured to switch current paths of the battery modules to be individually conducting or blocking;
a power management system configured to:
control the switching system;
when at least one of the battery modules has a state of charge that is lower than a state of charge of at least one other of the battery modules, switch a current path of the at least one battery module with the lower state of charge to be blocking while the electric vehicle is being driven, until the state of charge of the at least one battery module with a higher state of charge has balanced to the state of charge of the at least one battery module with the lower state of charge; and
then switch the current path of the at least one battery module with the previously lower state of charge to be conducting.

14. The electric vehicle according to claim 13, wherein the at least one battery state parameter is a module voltage.

15. The electric vehicle according to claim 13, comprising:
at least one receptacle for the plurality of battery modules which can be removed from their receptacle by a user and can be charged by the user.

16. The electric vehicle according to claim 13, wherein a respective battery module is configured to provide an electrical output of at least 7 kW.

17. The electric vehicle according to claim 13, wherein the electric vehicle is an electrically powered motorcycle.

18. The electric vehicle according to claim 13, wherein the electric vehicle is an electrically powered small car.

19. The electric vehicle according to claim 13, comprising a receptacle for precisely two battery modules.

20. The electric vehicle according to claim 13, wherein the battery modules have a same nominal output.

21. The electric vehicle according to claim 13, wherein at least two of the battery modules have a different nominal output.

22. The electric vehicle according to claim 13, wherein the power management system is configured to switch current paths of at least enough battery modules to be conducting that a power requirement of the electric vehicle can be met by the battery modules that are switched to be conducting.

23. The electric vehicle according to claim 13, comprising:
at least one receptacle fitted with battery modules.

24. A method for balancing states of charge of a plurality of battery modules of an electric vehicle, which are electrically connected in parallel and have a same nominal module voltage, comprising:
while the electric vehicle is being driven:
determining at least one battery state parameter that represents a state of charge of the battery modules;
in response to at least one of the battery modules having a state of charge that is markedly lower than a state of charge of at least one other of the battery modules, disconnecting at least one battery module with the lower state of charge until the state of charge of the at least one battery module with a higher state of charge has balanced to the state of charge of the at least one battery module with the lower state of charge; and
subsequently connecting the at least one battery module with the lower state of charge.

25. The method according to claim 24, wherein the at least one battery state parameter is a module voltage.

26. The method according to claim 24, wherein the plurality of battery modules can be removed from a receptacle by a user and can be charged by the user.

27. The method according to claim 24, comprising:
providing, by a respective battery module, an electrical output of at least 7 kW.

28. The method according to claim 24, comprising:
switching, by a power management system, current paths of at least enough battery modules to be conducting that a power requirement of the electric vehicle can be met by the battery modules that are switched to be conducting.
